(19) United States
(12) Patent Application Publication
(10) Pub. No.: US 2020/0117788 A1
(43) Pub. Date: Apr. 16, 2020

(54) Gesture Based Authentication for Payment in Virtual Reality

(71) Applicant: NCR Corporation, Atlanta, GA (US)

(72) Inventor: Jamal Mohiuddin Mohammad, Karimnagar (IN)

(21) Appl. No.: 16/157,782

(22) Filed: Oct. 11, 2018

(51) Int. Cl. G06F 21/36; G06N 99/00; G06Q 20/12; G06F 3/01; G06K 9/00

(52) U.S. Cl. CPC G06F 21/36; G06N 99/005; G06Q 20/12; G06F 3/013; G06K 9/00355; G06F 3/012; G06F 3/017

(57) ABSTRACT

A computer implemented method includes receiving training input corresponding to multiple different prompted user gestures, training a machine learning system on the training input, receiving an authentication input based on an authentication gesture performed by the user, and associating the authentication input with a transaction authentication operation utilizing the machine learning system in a virtual environment.

### BACKGROUND

Virtual Reality enables consumers to view products in a virtual environment prior to purchase. For example, when buying a piece of furniture for a room, a virtual representation of the room with the piece of furniture may be provided to give the consumer a better idea of how a purchase may look in a reality. From the virtual environment, the purchase may be completed either via ecommerce or going to a physical store. When completing a purchase at a physical store, the consumer/user removes a headset used to view the virtual environment and travels to the store to provide a credit card, sign a payment agreement, provide cash or a check, or otherwise provide payment. For ecommerce, a user exits the virtual reality to enter payment information. One current method of paying while still in the virtual environment includes the use of a Virtual Pin Pad or Key Pad. The virtual key pad may appear in the virtual environment, allowing the user to select a payment password associated with credit by staring at characters one by one. Such a payment method is cumbersome and slow and is basically not user friendly.

### SUMMARY

A computer implemented method includes receiving training input corresponding to multiple different prompted user gestures, training a machine learning system on the training input, receiving an authentication input based on an authentication gesture performed by the user, and associating the authentication input with a transaction authentication operation utilizing the machine learning system in a virtual environment.

### BRIEF DESCRIPTION OF THE DRAWINGS

FIG. 1 is a block diagram of a system for facilitating user interaction with a virtual reality environment according to an example embodiment.

FIG. 2 is a flowchart representation of a method of training a machine learning program for gesture based authorization according to an example embodiment.

FIG. 3 is a diagram illustrating various training gestures according to an example embodiment.

FIG. 4 is a flowchart illustrating a further method of using gestures to authorize transaction according to an example embodiment.

FIG. 5 is a block diagram of a machine learning system according to an example environment.

FIG. 6 is a block flow diagram illustrating a computer implemented method 600 of using a registered authentication gesture to authenticate an interaction or transaction while a user remains in a virtual environment according to an example embodiment.

FIG. 7 is a block diagram of computer system used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware-based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

Virtual reality environments provided by computing resources enables users to experience a computer-generated environment. In such an environment, users may be able to move interact within a multi-dimensional space. Some interactions in the environment may require a separate authorization. Prior authorizations may have involved a user having to exit the virtual reality to provide passwords or other authorizing constructs, or perhaps stay within the virtual reality, but utilize cumbersome interfaces to enter a pin. In various embodiments of the present inventive subject matter, authorization may be obtained by capturing motions or gestures of a user and comparing them to previously captured motions or gestures. A positive comparison results in a positive authorization, allowing the interaction to proceed.

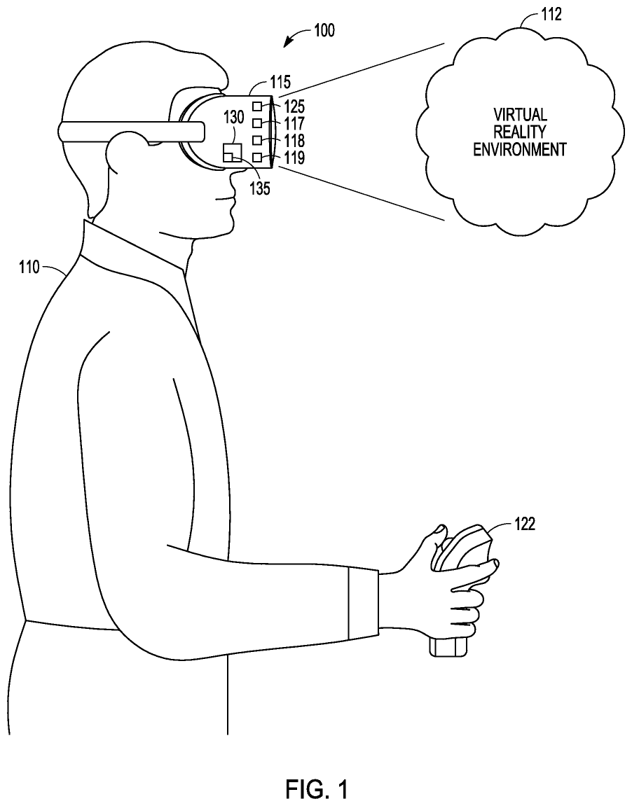

FIG. 1 is a block diagram of a system 100 for facilitating user 110 interaction with a virtual reality environment 112. The user 110 may utilize a virtual reality headset, such as a head mounted display (HMD) 115. HMD 115 may include one or more sensors, such as gyroscope 117, accelerometer 118, and magnetometer 119 that provide motion data related to user head movements. Note that there may be multiple of each type of sensor to track motion in different dimensions.

The user 110 may also utilize one or more controllers 122 for use by one or more hands of the user. Such controllers may be attached to one or more hands of the user, or simply held by the user. The movement of the hand may be sensed by the controller or controllers to provide the appearance that the users hand or hands are actually being used in the virtual reality environment. While shown as a block, controller 122 may be in the shape of a glove to fit the user's hand, or may be any other means of sensing hand movements.

Eye tracking may also be performed vi the HMD 115 using one or more sensors, such as an infrared sensor or other imaging device 125 to monitor or sense eye position within the HMD 115. The imaging device 125 provides angular data over time to allow the system 100 to determine where a user is looking within the virtual environment.

System 100 may include computing or processing resources 130 that provides a view of the virtual environment 112 and receives sensor data from the multiple sensors tracking motion or gestures. The virtual environment 112 is shown distant from the HMD 115 to represent the view perceived by a user on a display or displays internal to the HMD 115. Processing resources 130 receives the sensor data and controls the virtual environment in response to the sensor data. For instance, a user turning their head will cause a view of the virtual environment 115 to shift in accordance with the movement.

Moving a hand may be sensed by the controller 122 and cause the virtual environment to move an object, such as a ball or product that is being gripped by the hand, or an avatar of the hand to move in accordance with the sensed data provided by the sensors associated with the hand. The sensed hand motion or sensed eye movement may also be used to select navigation within the virtual environment, initiate transactions within the virtual environment, change the environment, cause drop down menus to be displayed, select icons or buttons within the virtual environment, and a myriad of other ways of interacting and conducting transactions within the virtual environment, including interactions within current video games to select weapons, fire weapons, collect objects, etc.

Some of the interactions, such as making a payment for a product or service appearing with in the virtual environment may require proper authentication that the user is authorized to utilize a payment mechanism. A payment mechanism to enable conclusion of a transaction may include an account that is associated with the virtual environment by the user. In one embodiment, an authorization gesture that the processing resources 130 has been trained to recognize and distinguish from other gestures by people other than the user, may be performed by the user to authorize the interaction.

The processing resources 130 may include a computer system having one or more processors and memory, either implemented as a stand-alone computer system, a server, or cloud-based resources, or a combination thereof. Wireless or wired communications may be included to enable use of remote processing resources. The processing resources 130 may be configured to execute a machine learning program 135, such as a neural network to perform gesture-based authorization.

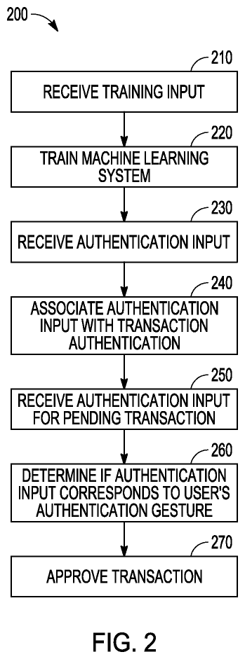

Several different gestures performed by user 110 are used to train the machine learning program 135. A computer implemented method 200 of training the machine learning program 135 to cause the processing resources 130 to perform gesture-based authorization is illustrated in flowchart form in FIG. 2. In one embodiment, method 200 may be performed by a computer having one or more processors and memory storing instructions for execution by the one or more processors to perform operations. At operation 210, training input corresponding to multiple different prompted user gestures is received. At operation 220, a machine learning system is trained on the training input. The user will then perform an authentication gesture selected by the user, with a corresponding authentication input being received. The authentication input is provided to the trained machine learning system at operation 230. The authentication input at operation 240 is associated with a transaction authentication operation utilizing the machine learning system in a virtual environment.

In one embodiment, method 200 includes receiving the authentication input in association with a pending transaction as indicated at operation 250. The machine learning system is then used at operation 260 to determine that the authentication input corresponds to the user's authentication gesture. At operation 270, the pending transaction is approved in response to the machine learning system determining that the authentication input corresponds to the user's authentication gesture.

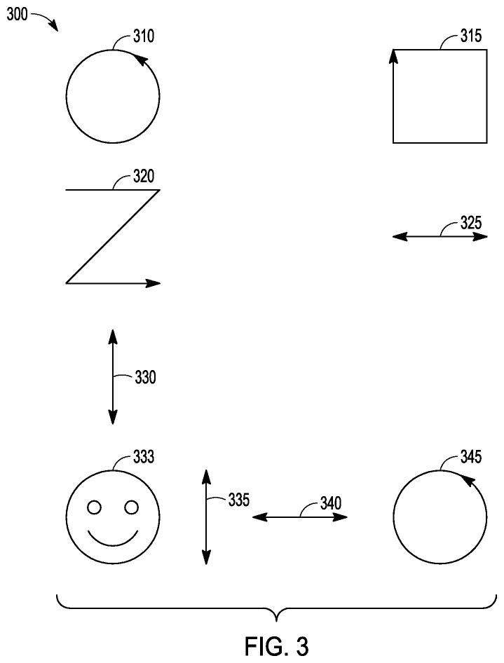

At operation 210, the method prompts a user to input specific hand gestures, such as those illustrated in FIG. 3 generally at 300. Such gestures may include at least one of making a circle gesture 310 with a hand, making a square gesture 315 with the hand, making a “Z” shaped gesture 320 with the hand, making a line forward and backward gesture 325 in a horizontal plane with respect to an upright user with the hand, and making a hand shake gesture 330 in a vertical plane with the hand.

Operation 210 may also prompt a user to input specific head 333 gestures. Such head gestures may include at least one of nodding the head, shaking the head, and rolling the head respectfully as represented by arrows 335, 340, and 345 respectively.

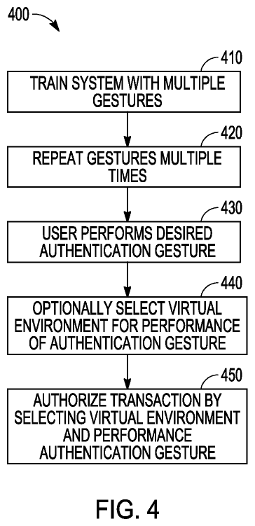

FIG. 4 is a flowchart illustrating a further method 400 of using gestures to authorize transaction. The training input is received by the machine learning system at operation 410 and may include multiple user gestures of each of the multiple different prompted user gestures. For instance, a user may be prompted to draw a circle several times, and draw square or triangle, or other shape or motion several times at operation 420 to ensure the machine learning systems has sufficient data to accurate classify hand gestures as hand gestures of the user, as well as to classify the authentication gesture correctly.

The authentication gesture is then performed by the user at operation 430 and may include multiple different gestures performed in sequence. The multiple different gestures may include at least two of a hand gesture, a head gesture, and an eye gesture, or may include multiple gestures of the same type of gesture, such as drawing a square, followed by a circle, followed by nodding of the head up and down.

In one embodiment, the authentication gesture includes an interactive gesture in a virtual environment selected at operation 440. For example, the user may select a virtual environment that appears like a garden, and may proceed to pick weeds, or vegetables, or perform another gardening activity or two. If the interactive environment selected is related to a physical activity, like catching a ball, the user may perform an authentication gesture that comprises catching a ball, or shooting a free throw, or hitting a golf ball, etc. The transaction authentication may also include receiving a selection of the selected environment from the user at operation 450 followed by performing the authentication gesture in that environment.

During training, the user may be prompted to perform multiple gestures as illustrated in FIG. 3. In one embodiment, the gestures may be selected from the group consisting of nodding of the head, shaking the head, rolling the head, making a circle using a hand, making a square using a hand, making a line forward and then backward, making a “z” shaped motion with a hand, making an angular “8” shaped motion that appears like an “8” shape with all straight lines—like two triangles with apexes meeting in a vertical orientation, and shaking of the hand up and down, like a handshake with another person. The system 110 may have a set number of times each motion should be performed in order to collect sufficient data to distinguish users. Higher accuracy of authentication may be provided with more repetitions of the training data gestures. A higher confidence level may be provided by machine learning program 135, resulting in a higher the accuracy of authentication.

The HMD sensors 117, 118, and 119 provide sensed data associated with the above gestures related to head motion. The sensed data may include sets of three dimensional coordinates associated with a time taken over selected intervals during the motion, rotational deviations, and orientation data based on magnetic fields. Each motion provides data representative of a specific user's gestures. As each user has muscle memory that is different, the collected data sensed from the authentication gesture, along with the type or shape of the authentication gesture performed, can be used to substantially uniquely identify the user by the machine learning program 135. Imaging device 125 may provide similar data related to eye position.

Similarly, the controller or controllers 122 associated with one or more hands of the user are used to provide data related to the motions performed by the hand. The data also includes one or more of sets of coordinates and associated time collected periodically over time, and other data depending on the types of sensors used.

Following this initial training, a user may then be prompted to generate their own authentication gesture to be used for authentication of interactions. As the user is performing their own authentication gesture, data is collected from the various sensors involved. The user may combine both hand, head, or eye movement, and create a complex authentication gesture. For example, one of the gestures can include: “making a square using a hand and then rotating the head towards the right”. The machine learning program 135 learns the movements associated with the authentication gesture, effectively registering the authentication gesture for that user.

In one embodiment, the authentication gesture may include adding interactive elements. In one example, a user may be prompted by the system 100 to hold a particular object or catch a particular object. The way the user holds the object, such as a ball, may be registered as the authentication gesture for that user.

In a further embodiment, additional security may be provided by having a user select a virtual environment from multiple different available virtual environments, such as beach environment, desert environment, garden environment, or other monumental environment. The selection may be made by tracking eye movement between multiple icons in the virtual environment. Looking at one icon for a selected amount of time may indicate such selection.

Artificial intelligence (AI) is a field concerned with developing decision-making systems to perform cognitive tasks that have traditionally required a living actor, such as a person. Artificial neural networks (ANNs) are computational structures that are loosely modeled on biological neurons. Generally, ANNs encode information (e.g., data or decision making) via weighted connections (e.g., synapses) between nodes (e.g., neurons). Modern ANNs are foundational to many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others.

Many ANNs are represented as matrices of weights that correspond to the modeled connections. ANNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the ANN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the ANN processing.

The correct operation of most ANNs relies on correct weights. However, ANN designers do not generally know which weights will work for a given application. Instead, a training process is used to arrive at appropriate weights. ANN designers typically choose a number of neuron layers or specific connections between layers including circular connection, but the ANN designer does not generally know which weights will work for a given application. Instead, a training process generally proceeds by selecting initial weights, which may be randomly selected. Training data is fed into the ANN and results are compared to an objective function that provides an indication of error. The error indication is a measure of how wrong the ANN's result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value, or exhibit other undesirable behavior. Variable step sizes may be attempted to provide faster convergence without the downsides of large step sizes.

Backpropagation is a technique whereby training data is fed forward through the ANN—here “forward” means that the data starts at the input neurons and follows the directed graph of neuron connections until the output neurons are reached—and the objective function is applied backwards through the ANN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of ANNs.

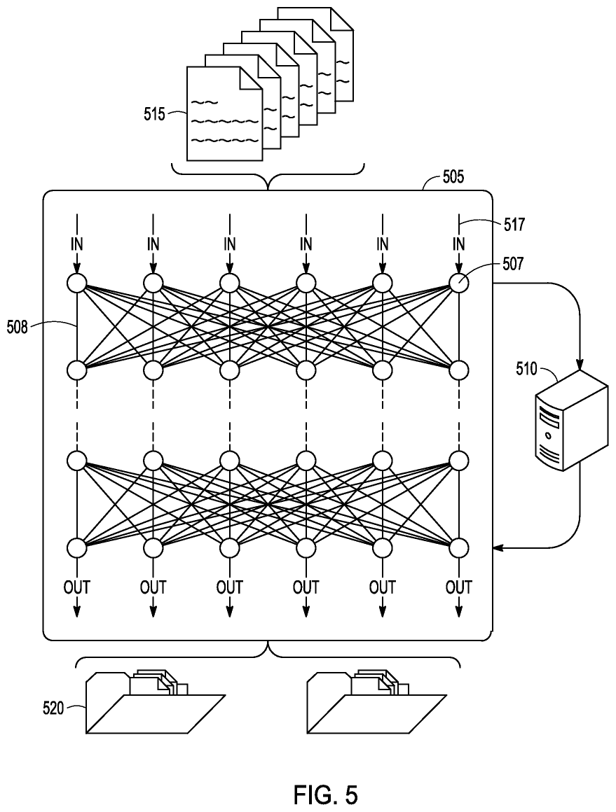

FIG. 5 is a block diagram of an example of an environment including a system for neural network training, according to an embodiment. The system includes an ANN 505 that is trained using a processing node 510. The processing node 510 may be a CPU, GPU, field programmable gate array (FPGA), digital signal processor (DSP), application specific integrated circuit (ASIC), or other processing circuitry. In an example, multiple processing nodes may be employed to train different layers of the ANN 505, or even different nodes 507 within layers. Thus, a set of processing nodes 510 is arranged to perform the training of the ANN 505.

The set of processing nodes 510 is arranged to receive a training set 515 for the ANN 505. The ANN 505 comprises a set of nodes 507 arranged in layers (illustrated as rows of nodes 507) and a set of inter-node weights 508 (e.g., parameters) between nodes in the set of nodes. In an example, the training set 515 is a subset of a complete training set. Here, the subset may enable processing nodes with limited storage resources to participate in training the ANN 505.

The training data may include multiple numerical values representative of a domain, such as red, green, and blue pixel values and intensity values for an image or pitch and volume values at discrete times for speech recognition. In various embodiments, the training data includes sensed data from multiple gestures performed by user 110 as described in further detail below. Each value of the training, or input 517 to be classified once ANN 505 is trained, is provided to a corresponding node 507 in the first layer or input layer of ANN 505. The values propagate through the layers and are changed by the objective function.

As noted above, the set of processing nodes is arranged to train the neural network to create a trained neural network. Once trained, data input into the ANN will produce valid classifications 520 (e.g., the input data 517 will be assigned into categories), for example. The training performed by the set of processing nodes 507 is iterative. In an example, each iteration of the training the neural network is performed independently between layers of the ANN 505. Thus, two distinct layers may be processed in parallel by different members of the set of processing nodes. In an example, different layers of the ANN 505 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 507 (e.g., neurons) are trained independently. In an example, the nodes are trained on different hardware.

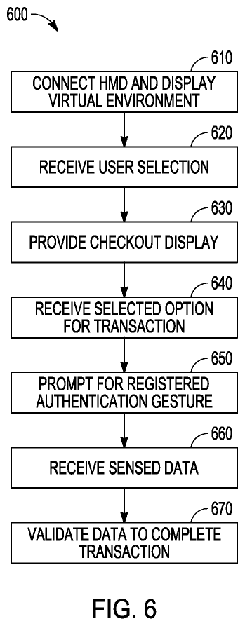

FIG. 6 is a block flow diagram illustrating a computer implemented method 600 of using a registered authentication gesture to authenticate an interaction or transaction while a user remains in a virtual environment. At operation 610, a VR headset, such as HMD 115 is worn by a user and connected to processing resources 130. The HMD 115 provides a user with a display of a virtual environment generated by the processing resources. One aspect of the virtual environment may include a representation of a product or service which the user may purchase. At operation 620, the user may select products, which may include services that they wish to purchase. Products may be selected by various means, such as using hand movements or focusing on a representation of a purchase button to place a product in a virtual cart. Once all the products are selected, a checkout display may be provided at operation 630 in the virtual environment. The user may then select an option for paying for a purchase at 640. All existing options may be displayed which include Net Banking, Wallets, Debit Card/Credit Card, or “NCR Fast Pay”. In response to the user selecting a payment option, in one example NCR Pay, the HMD display will prompt the user for a registered authentication gesture at operation 650 to complete the transaction at operation. At operation 660, in response to the user using the controller and or HMD to perform the registered authentication gesture, sensed data corresponding to the performed authentication gesture is received to enable the payment method to be used to complete the transaction. At operation 670, the sensed data representative of the sensed authentication gesture is sent to the processing resources 130 and the gesture is authenticated or validated via the machine learning program with the registered authentication gesture and the transaction is completed. Further security measures can be taken at remote processing resources, such as an NCR Server, to validate the user is at a known location using utilizing global positioning system data readily available from most current wireless devices.

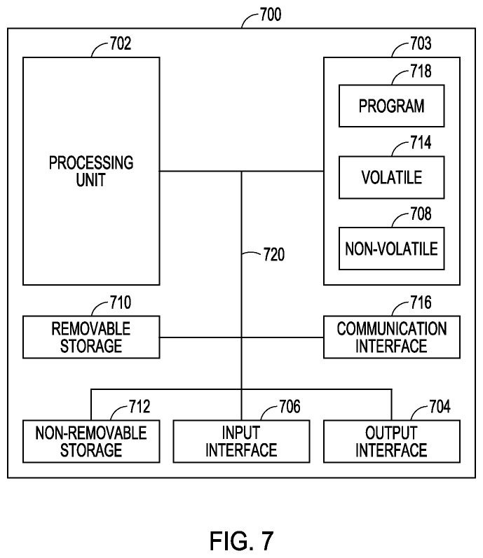

FIG. 7 is a block schematic diagram of a computer system 700 to implement processing resources 130, machine learning program 135, virtual environment generation, transaction processing, and other computing resources according to example embodiments. All components need not be used in various embodiments. One example computing device in the form of a computer 700, may include a processing unit 702, memory 703, removable storage 710, and non-removable storage 712. Sensors may be coupled to provide data to the processing unit 702. Memory 703 may include volatile memory 714 and non-volatile memory 708.

Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 700 may include or have access to a computing environment that includes input 706, output 704, and a communication connection 716. Output 704 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks. According to one embodiment, the various components of computer 700 are connected with a system bus 720.

Computer-readable instructions stored on a computer-readable medium are executable by the processing unit 702 of the computer 700. The program 718 in some embodiments comprises software to implement the machine learning system and one or more methods and operations described herein. A hard drive, CD-ROM, DRAM, and RAM are some examples of devices including a non-transitory computer-readable medium. The terms computer-readable medium and storage device do not include wireless signals, such as carrier waves or other communication or transmission media to the extent signals, carrier waves, or other media are deemed too transitory.

For example, a computer program 718 may be used to cause processing unit 702 to perform one or more methods or algorithms described herein. Computer program 718 may be stored on a device or may be downloaded from a server to a device over a network such as the Internet.

### Examples

1. A computer implemented method includes receiving training input corresponding to multiple different prompted user gestures training a machine learning system on the training input receiving an authentication input based on an authentication gesture performed by the user, and associating the authentication input with a transaction authentication operation utilizing the machine learning system in a virtual environment.
2. The method of example 1 and further comprising prompting a user to input specific hand gestures.
3. The method of example 2 wherein the specific hand gestures include at least one of making a circle gesture with a hand, making a square gesture with the hand, making a “Z” shaped gesture with the hand, making a line forward and backward gesture with the hand, and making a hand shake gesture with the hand.
4. The method of any of examples 1-3 and further comprising prompting a user to input specific head gestures.
5. The method of example 4 wherein the specific head gestures include at least one of nodding the head, shaking the head, and rolling the head.
6. The method of any of examples 1-5 wherein the training input includes multiple user gestures of each of the multiple different prompted user gestures.
7. The method of any of examples 1-6 wherein the authentication gesture includes multiple different gestures performed in sequence.
8. The method of example 7 wherein the multiple different gestures include at least two of a hand gesture, a head gesture, and an eye gesture.
9. The method of any of examples 1-8 wherein the authentication gesture includes an interactive gesture in a selected virtual environment.
10. The method of example 9 wherein the transaction authentication includes receiving a selection of the selected environment from the user.
11. The method of any of examples 1-10 and further including receiving the authentication input in association with a pending transaction, using the machine learning system to determine that the authentication input corresponds to the user's authentication gesture, and approving the pending transaction in response to the machine learning system determining that the authentication input corresponds to the user's authentication gesture.
12. A computing device including a processor and a memory device coupled to the processor having instructions stored thereon executable by the processor to perform operations. The operations include receiving training input corresponding to multiple different prompted user gestures, training a machine learning system on the training input, receiving an authentication input based on an authentication gesture performed by the user, and associating the authentication input with a transaction authentication operation utilizing the machine learning system in a virtual environment.
13. The computing device of example 12 wherein the operations further include prompting a user to input specific hand gestures, wherein the specific hand gestures include at least one of making a circle gesture with a hand, making a square gesture with the hand, making a “Z” shaped gesture with the hand, making a line forward and backward gesture with the hand, and making a hand shake gesture with the hand, and prompting a user to input specific head gestures, wherein the specific head gestures include at least one of nodding the head, shaking the head, and rolling the head.
14. The computing device of any of examples 12-13 wherein the training input includes multiple user gestures of each of the multiple different prompted user gestures.
15. The computing device of any of examples 12-14 wherein the authentication gesture includes multiple different gestures performed in sequence, wherein the multiple different gestures include at least two of a hand gesture, a head gesture, and an eye gesture.
16. The computing device of any of examples 12-15 wherein the authentication gesture includes an interactive gesture in a selected virtual environment and wherein the transaction authentication includes receiving a selection of the selected environment from the user.
17. The computing device of any of examples 12-16 wherein the operations further include receiving the authentication input in association with a pending transaction, using the machine learning system to determine that the authentication input corresponds to the user's authentication gesture, and approving the pending transaction in response to the machine learning system determining that the authentication input corresponds to the user's authentication gesture.
18. A machine-readable storage device having instructions that are executable by a processor to perform operations. The operations include receiving training input corresponding to multiple different prompted user gestures, training a machine learning system on the training input, receiving an authentication input based on an authentication gesture performed by the user, and associating the authentication input with a transaction authentication operation utilizing the machine learning system in a virtual environment.
19. The machine-readable storage device of example 18 wherein the operations further include prompting a user to input specific hand gestures, wherein the specific hand gestures include at least one of making a circle gesture with a hand, making a square gesture with the hand, making a “Z” shaped gesture with the hand, making a line forward and backward gesture with the hand, and making a hand shake gesture with the hand, and prompting a user to input specific head gestures, wherein the specific head gestures include at least one of nodding the head, shaking the head, and rolling the head, and wherein the authentication gesture includes multiple different gestures performed in sequence, wherein the multiple different gestures include at least two of a hand gesture, a head gesture, and an eye gesture.
20. The machine-readable storage device of any of examples 18-19 wherein the operations further include receiving the authentication input in association with a pending transaction, using the machine learning system to determine that the authentication input corresponds to the user's authentication gesture, and approving the pending transaction in response to the machine learning system determining that the authentication input corresponds to the user's authentication gesture.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving training input corresponding to multiple different prompted user gestures;
training a machine learning system on the training input;
receiving an authentication input based on an authentication gesture performed by the user; and
associating the authentication input with a transaction authentication operation utilizing the machine learning system in a virtual environment.

2. The method of claim 1 and further comprising prompting a user to input specific hand gestures.

3. The method of claim 2 wherein the specific hand gestures include at least one of making a circle gesture with a hand, making a square gesture with the hand, making a “Z” shaped gesture with the hand, making a line forward and backward gesture with the hand, and making a hand shake gesture with the hand.

4. The method of claim 1 and further comprising prompting a user to input specific head gestures.

5. The method of claim 4 wherein the specific head gestures include at least one of nodding the head, shaking the head, and rolling the head.

6. The method of claim 1 wherein the training input includes multiple user gestures of each of the multiple different prompted user gestures.

7. The method of claim 1 wherein the authentication gesture includes multiple different gestures performed in sequence.

8. The method of claim 7 wherein the multiple different gestures include at least two of a hand gesture, a head gesture, and an eye gesture.

9. The method of claim 1 wherein the authentication gesture includes an interactive gesture in a selected virtual environment.

10. The method of claim 9 wherein the transaction authentication includes receiving a selection of the selected environment from the user.

11. The method of claim 1 and further comprising:
receiving the authentication input in association with a pending transaction;
using the machine learning system to determine that the authentication input corresponds to the user's authentication gesture; and
approving the pending transaction in response to the machine learning system determining that the authentication input corresponds to the user's authentication gesture.

12. A computing device comprising:
a processor; and
a memory device coupled to the processor having instructions stored thereon executable by the processor to perform operations comprising:
receiving training input corresponding to multiple different prompted user gestures;
training a machine learning system on the training input;
receiving an authentication input based on an authentication gesture performed by the user; and
associating the authentication input with a transaction authentication operation utilizing the machine learning system in a virtual environment.

13. The computing device of claim 12 and further including operations comprising:
prompting a user to input specific hand gestures, wherein the specific hand gestures include at least one of making a circle gesture with a hand, making a square gesture with the hand, making a “Z” shaped gesture with the hand, making a line forward and backward gesture with the hand, and making a hand shake gesture with the hand; and
prompting a user to input specific head gestures, wherein the specific head gestures include at least one of nodding the head, shaking the head, and rolling the head.

14. The computing device of claim 12 wherein the training input includes multiple user gestures of each of the multiple different prompted user gestures.

15. The computing device of claim 12 wherein the authentication gesture includes multiple different gestures performed in sequence, wherein the multiple different gestures include at least two of a hand gesture, a head gesture, and an eye gesture.

16. The computing device of claim 12 wherein the authentication gesture includes an interactive gesture in a selected virtual environment and wherein the transaction authentication includes receiving a selection of the selected environment from the user.

17. The computing device of claim 12 wherein the operations further comprise:
receiving the authentication input in association with a pending transaction;
using the machine learning system to determine that the authentication input corresponds to the user's authentication gesture; and
approving the pending transaction in response to the machine learning system determining that the authentication input corresponds to the user's authentication gesture.

18. A machine-readable storage device having instructions that are executable by a processor to perform operations comprising:
receiving training input corresponding to multiple different prompted user gestures;
training a machine learning system on the training input;
receiving an authentication input based on an authentication gesture performed by the user; and
associating the authentication input with a transaction authentication operation utilizing the machine learning system in a virtual environment.

19. The machine-readable storage device of claim 18 wherein the operations further comprise:
prompting a user to input specific hand gestures, wherein the specific hand gestures include at least one of making a circle gesture with a hand, making a square gesture with the hand, making a “Z” shaped gesture with the hand, making a line forward and backward gesture with the hand, and making a hand shake gesture with the hand; and
prompting a user to input specific head gestures, wherein the specific head gestures include at least one of nodding the head, shaking the head, and rolling the head, and wherein the authentication gesture includes multiple different gestures performed in sequence, wherein the multiple different gestures include at least two of a hand gesture, a head gesture, and an eye gesture.

20. The machine-readable storage device of claim 18 wherein the operations further comprise:
receiving the authentication input in association with a pending transaction;
using the machine learning system to determine that the authentication input corresponds to the user's authentication gesture; and
approving the pending transaction in response to the machine learning system determining that the authentication input corresponds to the user's authentication gesture.
